(19) United States
(12) Patent Application Publication
(10) Pub. No.: US 2013/0059099 A1
(43) Pub. Date: Mar. 7, 2013

(54) CEMENT-FREE ALKALI-ACTIVATED BINDING MATERIAL, AND MORTAR AND CONCRETE USING SAME

(71) Applicants: Jin Kyu Song, Gwangju (KR); Keun Hyeok Yang, Suwon (KR)

(72) Inventors: Jin Kyu Song, Gwangju (KR); Keun Hyeok Yang, Suwon (KR)

(73) Assignee: INDUSTRY FOUNDATION OF CHONNAM NATIONAL UNIVERSITY, Gwangju (KR)

(21) Appl. No.: 13/521,183

(22) PCT Filed: Jan. 13, 2011
(86) PCT No.: PCT/KR11/00262

§ 371 Date: Jul. 9, 2012

(30) Foreign Application Priority Data
Jan. 13, 2010 (KR) 10-2010-0003080

(51) Int. Cl. C04B 28/00

(52) U.S. Cl. 428/34.4; 106/789; 106/705; 106/707; 106/811; 106/790; 106/706; 106/801; 106/679; 106/681

(57) ABSTRACT

The present invention relates to a cement-free alkali-activated binder. More particularly, the present invention relates to a cement-free alkali-activated binder having a novel combination ratio, which can improve the compressive strength of mortar and concrete in which the cement-free alkali-activated binder is used as a binding material instead of cement, and which can solve the low field applicability of mortar and concrete in terms of quick setting characteristics, fluidity loss, economic efficiency and the like, and to mortar or concrete comprising the same. The cement-free alkali-activated binder can improve field applicability by controlling the content and combination ratio of an alkali activator included in the cement-free alkali-activated binder, and can solve the problems of the toxicity of cement, the carbon dioxide (CO²) produced during the manufacturing of cement and the exhaustion of natural resources due to the production of cement.

### CROSS REFERENCE TO RELATED APPLICATIONS AND CLAIM OF PRIORITY

This patent application is a National Phase application under 35 U.S.C. §371 of International Application No. PCT/KR2011/000262, filed on Jan. 13, 2011, which claims priority to Korean Patent Application number 10-2010-0003080 filed Jan. 13, 2010, entire contents of which are incorporated herein by reference.

### BACKGROUND

1. Technical Field

The present invention relates to an alkali-activated binder being free from cement. More particularly, the present invention relates to alkali-activated binder which is free from cement and has a novel combination ratio, which can improve the compressive strength of mortar and concrete in which the alkali-activated binder is used as a binding material instead of cement, and which can solve the low field applicability of mortar and concrete in terms of quick setting characteristics, fluidity loss, economic efficiency and the like, and to mortar or concrete including the same.

2. Background Art

Generally, mortar or concrete, which is used in the construction industry, includes a binding material, an aggregate, and water. In this case, in a process of manufacturing cement (or cement clinker), which is a typical inorganic binding material, an enormous amount of energy is consumed in the course of heat-treating limestone containing CaCO₃ as a major component, and a large amount of carbon dioxide (CO₂) gas is generated in an amount of 44 wt % or more based on the total amount of the manufactured cement. The amount of carbon dioxide (CO₂) gas generated in this way accounts for about 7% of the greenhouse gases emitted all over the world.

Meanwhile, the climate change and global warming attributable to greenhouse gases are seriously threatening all countries throughout the world. The Intergovernmental Panel on Climate Change (IPCC), which is a special research institution handling global warming and climate change, predicts that the atmospheric temperature of the earth will continuously increase during the 21^{st} century if international efforts to decrease the concentration of greenhouse gases in the air are not made.

Therefore, the production of cement clinker will be inevitably reduced depending on how the target value for the reduction of CO₂ is determined for the cement manufacturing industry in relation to the regulations governing CO₂ (greenhouse gas) emissions. It is predicted that the demand for cement all over the world will increase by 2.5˜5.8% every year until the early part of the 21^{st} century. Therefore, in order to satisfy both the observance of Kyoto Protocol and the increase in demand for cement, there is an urgent need to develop a novel inorganic binding material that reduces the emission of CO₂ or does not emit CO₂ at all.

Currently, in order to solve such a problem of reducing CO₂, domestic and foreign concrete manufacturing companies are showing concerns about environment-friendly concrete, and are thus making efforts to develop technologies for reducing the carbon dioxide produced during the manufacturing of ordinary portland cement (OPC).

Further, American Concrete Institute published a plan for making environment-friendly cement in the paper “Vision 2030: A Vision for the Concrete Industry”. In the problem of carbon dioxide in the concrete industry, the reduction of energy consumption must be actively taken into consideration with respect to each of the steps of source material mining, calcination, decomposition, transportation and construction. As the result of such efforts, concrete in which cement is partially replaced by an industrial by-product such as blast furnace slag, fly ash or the like is being gradually more generally used.

When the blast furnace slag produced from an iron mill is actively utilized, dependency on limestone can be lowered, so that the effect of improving global environment by recycling industrial waste as well as the effect of reducing environmental load can be expected, and the effect of improving the strength and durability of concrete can also be expected.

Owing to such efforts, research into alkali-activated binders, the strength of which is improved by partially introducing blast furnace slag or fly ash as an alternative to cement and adding an alkali activator, is being done both at home and abroad.

However, alkali-activated binders being free from cement (i.e., cement-free alkali-activated binders) are used as alternatives to cement and have been researched for the purpose of developing environment-friendly materials in the concrete industry. These materials have been generally used to do research on cement-free alkali-activated concrete including sodium silicate as an alkali activator. Target strength models of the cement-free alkali-activated concrete have also been proposed.

However, since the amount of the alkali activator added to secure the target strength of the alkali-activated concrete is increased, the alkali-activated concrete rapidly loses initial fluidity and sets quickly. Further, the alkali-activated concrete has the problem of low field applicability which needs to be solved, such as the increase in the manufacturing cost thereof in terms of economic efficiency due to the increase in the amount of the added alkali activator, or the like.

Therefore, in order to solve the above problems, it is required to develop a novel cement-free alkali-activated binder.

### SUMMARY

Accordingly, the present inventors made efforts to solve the above-mentioned conventional problems. As a result, they developed a cement-free alkali-activated binder, the field applicability of which is improved by controlling the content and combination ratio of an alkali activator included in the cement-free alkali-activated binder, thus completing the present invention.

Accordingly, an object of the present invention is to provide a cement-free alkali-activated binder including a complex alkali activator, which can improve the compressive strength of mortar and/or concrete to which the cement-free alkali-activated binder is applied, and which can solve low field applicability in terms of quick-setting characteristics, fluidity loss or the like, and provides mortar or concrete including the same.

Another object of the present invention is to provide a cement-free alkali-activated binder, which can have improved economic efficiency because the amount of an alkali activator added to obtain target concrete strength can be reduced by optimally combining alkali activators, that is, by using a complex alkali activator, and provides mortar or concrete including the same.

Still another object of the present invention is to provide a cement-free alkali-activated binder, which can exhibit excellent product stability because it can be used to obtain mortar or concrete having uniform strength compared to when using a conventional alkali-activated binder, and provides mortar or concrete including the same.

The objects of the present invention are not limited to the above-mentioned objects, and other objects thereof will be understandable by those skilled in the art from the following descriptions.

In order to accomplish the above objects, an aspect of the present invention provides a cement-free alkali-activated binder, including: at least one source material selected from the group consisting of slag, fly ash, and meta-kaolin; and a complex alkali activator including an alkaline hydroxide and a carbonate.

In the cement-free alkali-activated binder, the source material may be included in an amount of 88˜96 wt %, and the complex alkali activator may be included in an amount of 4˜12 wt %.

Further, the complex alkali activator may include the alkaline hydroxide and the carbonate such that the weight ratio thereof is 2˜4:4˜6.

Further, the alkaline hydroxide may be at least one selected from the group consisting of potassium hydroxide, sodium hydroxide, calcium hydroxide, magnesium hydroxide, and barium hydroxide.

Further, the carbonate may be at least one selected from the group consisting of potassium carbonate, sodium carbonate, magnesium carbonate, and barium carbonate.

Another aspect of the present invention provides a cement-free mortar, including the cement-free alkali-activated binder instead of cement

In the cement-free mortar, the cement-free alkali-activated binder may be mixed with sand such that a weight ratio thereof is 1:2˜3.

Still another aspect of the present invention provides a cement-free concrete, including the cement-free alkali-activated binder instead of cement

Still another aspect of the present invention provides a cement-free concrete product, manufactured using the cement-free concrete.

The cement-free concrete product may include a brick, a block, a tile, a sewage pipe, a boundary stone, a concrete pile, prestressed concrete, a concrete panel, a concrete pipe, a manhole, a foamed concrete, and a concrete structure.

The cement-free alkali-activated binder of the present invention has the following advantages.

The cement-free alkali-activated binder of the present invention can improve the compressive strength of mortar and/or concrete to which the cement-free alkali-activated binder is applied, and can solve the low field applicability thereof in terms of quick-setting characteristics, fluidity loss or the like.

Further, the cement-free alkali-activated binder of the present invention can have improved economic efficiency because the amount of an alkali activator added to obtain the target concrete strength can be reduced by optimally combining alkali activators, that is, by using a complex alkali activator.

Further, the cement-free alkali-activated binder of the present invention can exhibit excellent product stability because it can be used to obtain mortar or concrete having uniform strength, compared to when using a conventional alkali-activated binder.

### BRIEF DESCRIPTION OF DRAWINGS

FIG. 1 is a three-dimensional graph showing the compressive strengths of cement-free mortars 1 to 25 at a curing age of 28 days, the cement-free mortars 1 to 25 being manufactured using cement-free alkali-activated binders prepared according to Examples of the present invention;

FIG. 2 is a graph showing the relationship between the curing age and compressive strength of the cement-free mortars 1 to 4 of the cement-free mortars shown in FIG. 1;

FIG. 3 is a bar graph showing the compressive strengths of the cement-free mortars 1 to 4 shown in FIG. 1 at a curing age of 28 days;

FIG. 4 is a graph showing the relationship between the curing age and compressive strength of the cement-free mortars 6 to 10 of the cement-free mortars shown in FIG. 1;

FIG. 5 is a bar graph showing the compressive strengths of the cement-free mortars 6 to 10 shown in FIG. 1 at a curing age of 28 days;

FIG. 6 is a graph showing the relationship between the curing age and compressive strength of the cement-free mortars 11 to 15 of the cement-free mortars shown in FIG. 1;

FIG. 7 is a bar graph showing the compressive strengths of the cement-free mortars 11 to 15 shown in FIG. 1 at a curing age of 28 days;

FIG. 8 is a graph showing the relationship between the curing age and compressive strength of the cement-free mortars 16 to 20 of the cement-free mortars shown in FIG. 1;

FIG. 9 is a bar graph showing the compressive strengths of the cement-free mortars 16 to 20 shown in FIG. 1 at a curing age of 28 days;

FIG. 10 is a graph showing the relationship between the curing age and compressive strength of the cement-free mortars 21 to 25 of the cement-free mortars shown in FIG. 1;

FIG. 11 is a bar graph showing the compressive strengths of the cement-free mortars 21 to 25 shown in FIG. 1 at a curing age of 28 days; and

FIGS. 12 to 14 are graphs showing the setting characteristics of the cement-free mortars depending on the content of a complex alkali activator included in the cement-free alkali-activated binder according to the present invention.

### DETAILED DESCRIPTION

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

Hereinafter, preferred embodiments of the present invention will be described in detail with reference to the accompanying drawings.

However, the present invention is not limited to the following embodiments, and may be variously modified. Throughout the present specification, the same reference numerals are used to designate the same or similar components.

The present invention provides a cement-free alkali-activated binder which can replace cement, and mortar or concrete including the same. Particularly, the cement-free alkali-activated binder of the present invention is technically characterized in that at least one selected from the group consisting of slag, fly ash and meta-kaolin is used as a source material and in that a complex alkali activator including an alkaline hydroxide containing a hydroxide ion (OH⁻) and a carbonate containing a carbonate ion (CO₃²⁻) at a predetermined weight ratio is used as an alkali activator.

That is, in the present invention, the complex alkali activator including two or more kinds of alkaline inorganic materials mixed at a predetermined combination ratio is used instead of an alkali activator (that is, an alkaline inorganic material) which is independently used in a conventional cement-free alkali-activated binder. As a result, the strength and field applicability of a mortar or concrete including this complex alkali activator are remarkably improved.

Further, according to the present invention, the problems of the toxicity of cement, the carbon dioxide (CO²) produced during the manufacturing of cement and the exhaustion of natural resources due to the production of cement can be solved, the production cost of mortar or concrete can be reduced by decreasing the amount of the added alkaline inorganic material, and mortar or concrete having uniform strength can be obtained, thus improving product stability.

More specifically, the cement-free alkali-activated binder may include 88˜96 wt % of the source material and 4˜12 wt % of the complex alkali activator. Here, the source material may have a blaine fineness of 4000 cm²/g or more. The slag may be at least one selected from blast furnace slag, electric furnace slag and converter slag. Preferably, the slag may be blast furnace slag.

Further, the complex alkali activator may include the alkaline hydroxide and the carbonate such that the weight ratio thereof is 2˜4:4˜6, and preferably 3:5.

Here, the alkaline hydroxide is a compound having alkalinity and containing a hydroxide ion (OH⁻), and may be at least one selected from the group consisting of potassium hydroxide, sodium hydroxide, calcium hydroxide, magnesium hydroxide, and barium hydroxide.

Further, the carbonate is a salt in which hydrogen of carbonic acid is substituted with metal, that is, a compound consisting of carbon dioxide and a metal oxide or carbon dioxide and a hydroxide, and contains a carbonate ion (CO₃²⁻). The carbonate may be at least one selected from the group consisting of potassium carbonate, sodium carbonate, magnesium carbonate, and barium carbonate.

Hereinafter, the present invention will be described in more detail with reference to the following Examples. Here, the term “GGBS” means ground granulated blast furnace slag which is fine blast furnace slag powder having a predetermined particle size.

### EXAMPLE 1

96 wt % of GGBS, 2 wt % of sodium hydroxide and 2 wt % of sodium carbonate were uniformly mixed to prepare a cement-free alkali-activated binder 1.

### EXAMPLE 2

95 wt % of GGBS, 2 wt % of sodium hydroxide and 3 wt % of sodium carbonate were uniformly mixed to prepare a cement-free alkali-activated binder 2.

### EXAMPLE 3

94 wt % of GGBS, 2 wt % of sodium hydroxide and 4 wt % of sodium carbonate were uniformly mixed to prepare a cement-free alkali-activated binder 3.

### EXAMPLE 4

93 wt % of GGBS, 2 wt % of sodium hydroxide and 5 wt % of sodium carbonate were uniformly mixed to prepare a cement-free alkali-activated binder 4.

### EXAMPLE 5

92 wt % of GGBS, 2 wt % of sodium hydroxide and 6 wt % of sodium carbonate were uniformly mixed to prepare a cement-free alkali-activated binder 5.

### EXAMPLE 6

95 wt % of GGBS, 3 wt % of sodium hydroxide and 2 wt % of sodium carbonate were uniformly mixed to prepare a cement-free alkali-activated binder 6.

### EXAMPLE 7

94 wt % of GGBS, 3 wt % of sodium hydroxide and 3 wt % of sodium carbonate were uniformly mixed to prepare a cement-free alkali-activated binder 7.

### EXAMPLE 8

93 wt % of GGBS, 3 wt % of sodium hydroxide and 4 wt % of sodium carbonate were uniformly mixed to prepare a cement-free alkali-activated binder 8.

### EXAMPLE 9

92 wt % of GGBS, 3 wt % of sodium hydroxide and 5 wt % of sodium carbonate were uniformly mixed to prepare a cement-free alkali-activated binder 9.

### EXAMPLE 10

91 wt % of GGBS, 3 wt % of sodium hydroxide and 6 wt % of sodium carbonate were uniformly mixed to prepare a cement-free alkali-activated binder 10.

### EXAMPLE 11

94 wt % of GGBS, 4 wt % of sodium hydroxide and 2 wt % of sodium carbonate were uniformly mixed to prepare a cement-free alkali-activated binder 11.

### EXAMPLE 12

93 wt % of GGBS, 4 wt % of sodium hydroxide and 3 wt % of sodium carbonate were uniformly mixed to prepare a cement-free alkali-activated binder 12.

### EXAMPLE 13

92 wt % of GGBS, 4 wt % of sodium hydroxide and 4 wt % of sodium carbonate were uniformly mixed to prepare a cement-free alkali-activated binder 13.

### EXAMPLE 14

91 wt % of GGBS, 4 wt % of sodium hydroxide and 5 wt % of sodium carbonate were uniformly mixed to prepare a cement-free alkali-activated binder 14.

### EXAMPLE 15

90 wt % of GGBS, 4 wt % of sodium hydroxide and 6 wt % of sodium carbonate were uniformly mixed to prepare a cement-free alkali-activated binder 15.

### EXAMPLE 16

93 wt % of GGBS, 5 wt % of sodium hydroxide and 2 wt % of sodium carbonate were uniformly mixed to prepare a cement-free alkali-activated binder 16.

### EXAMPLE 17

92 wt % of GGBS, 5 wt % of sodium hydroxide and 3 wt % of sodium carbonate were uniformly mixed to prepare a cement-free alkali-activated binder 17.

### EXAMPLE 18

91 wt % of GGBS, 5 wt % of sodium hydroxide and 4 wt % of sodium carbonate were uniformly mixed to prepare a cement-free alkali-activated binder 18.

### EXAMPLE 19

90 wt % of GGBS, 5 wt % of sodium hydroxide and 5 wt % of sodium carbonate were uniformly mixed to prepare a cement-free alkali-activated binder 19.

### EXAMPLE 20

89 wt % of GGBS, 5 wt % of sodium hydroxide and 6 wt % of sodium carbonate were uniformly mixed to prepare a cement-free alkali-activated binder 20.

### EXAMPLE 21

92 wt % of GGBS, 6 wt % of sodium hydroxide and 2 wt % of sodium carbonate were uniformly mixed to prepare a cement-free alkali-activated binder 21.

### EXAMPLE 22

91 wt % of GGBS, 6 wt % of sodium hydroxide and 3 wt % of sodium carbonate were uniformly mixed to prepare a cement-free alkali-activated binder 22.

### EXAMPLE 23

90 wt % of GGBS, 6 wt % of sodium hydroxide and 4 wt % of sodium carbonate were uniformly mixed to prepare a cement-free alkali-activated binder 23.

### EXAMPLE 24

89 wt % of GGBS, 6 wt % of sodium hydroxide and 5 wt % of sodium carbonate were uniformly mixed to prepare a cement-free alkali-activated binder 24.

### EXAMPLE 25

88 wt % of GGBS, 6 wt % of sodium hydroxide and 6 wt % of sodium carbonate were uniformly mixed to prepare a cement-free alkali-activated binder 25.

### EXAMPLE 26

Water (W), the cement-free alkali-activated binder 1 (B) prepared in Example 1, and fine aggregates (A) were mixed such that the combination ratio (WB) of the water and the cement-free alkali-activated binder 1 (B) was 50% by weight and the combination ratio (B/A) of the cement-free alkali-activated binder 1 (B) and the aggregates (A) was 1:2.45, and then the mixture was uniformly stirred to manufacture a cement-free mortar 1.

### EXAMPLES 27 TO 50

Cement-free mortars 2 to 25 were respectively manufactured in the same manner as in Example 25, except that the cement-free alkali-activated binders 2 to 25 prepared in Examples 2 to 25 were respectively used instead of the cement-free alkali-activated binder 1 prepared in Example 1.

### Test Example 1

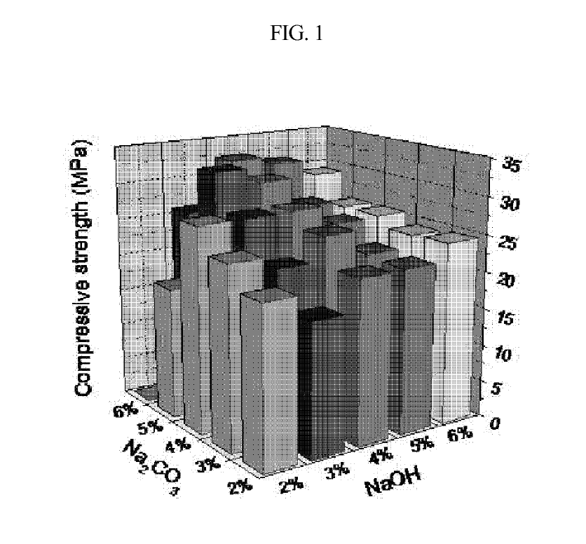

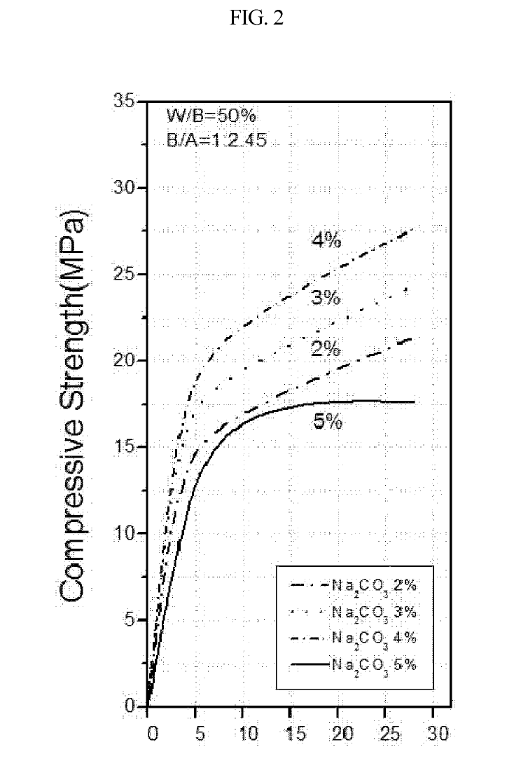

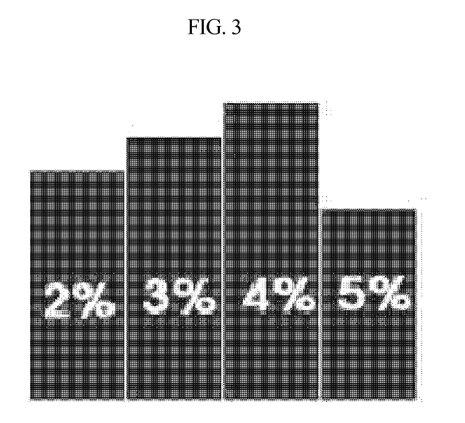

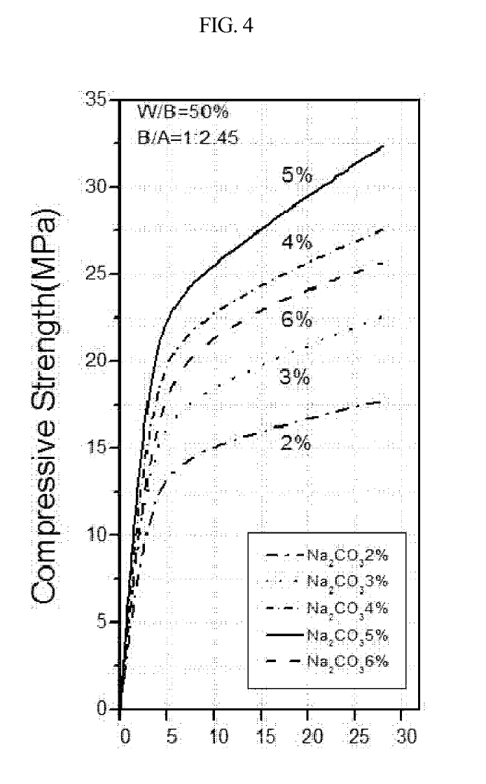

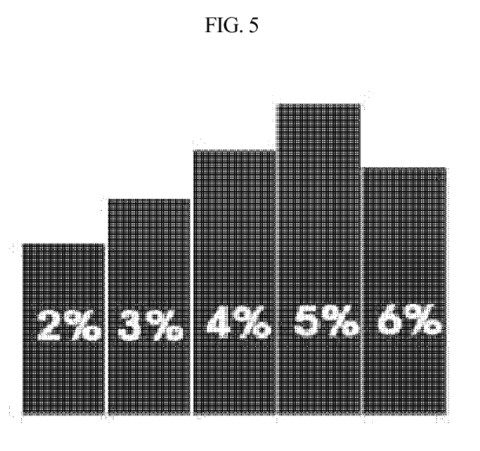

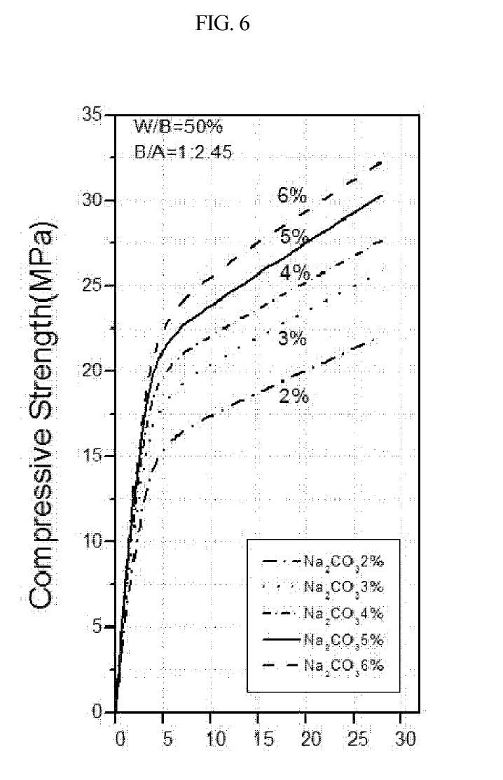

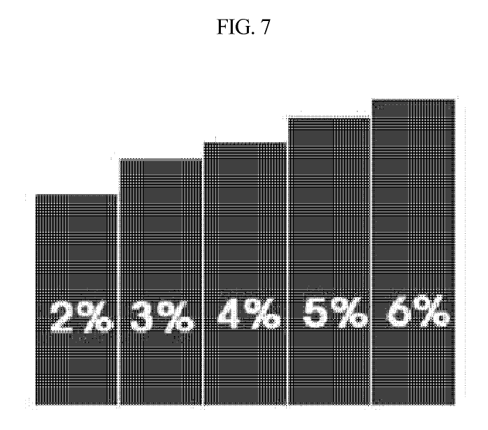

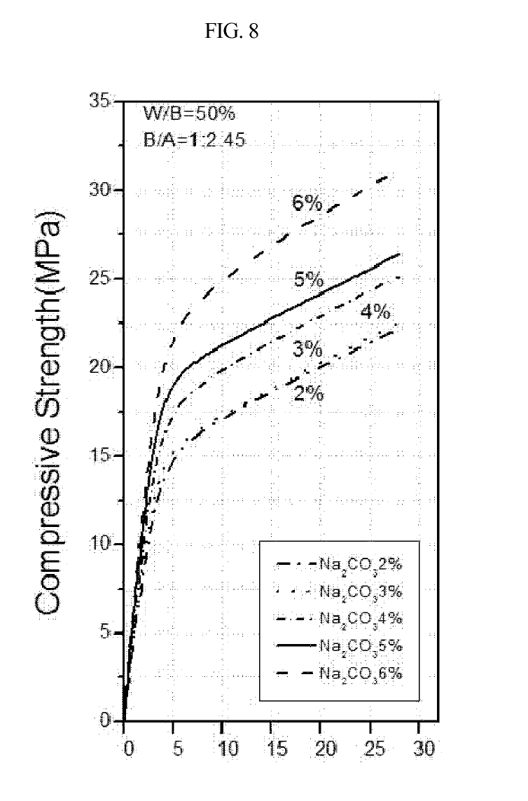

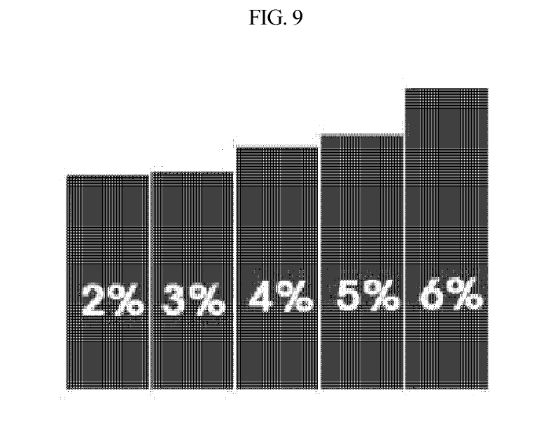

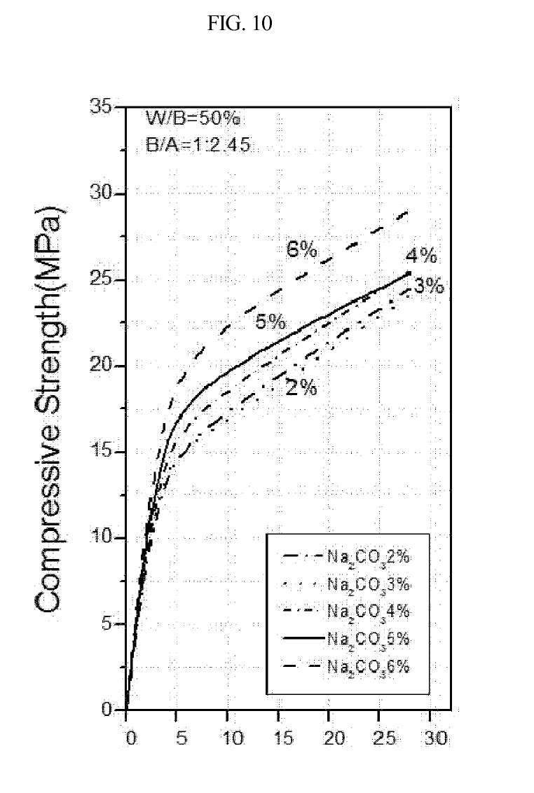

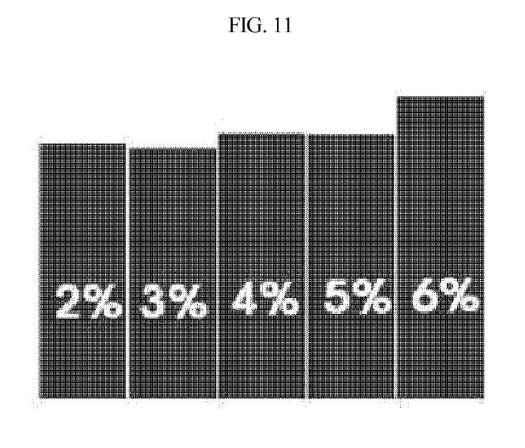

The cement-free mortars manufactured in Examples 26 to 50 were cured at room temperature, the compressive strengths of the cured cement-free mortars depending on the content of a complex alkali activator were tested, and the results thereof are shown in FIGS. 1 to 11.

Referring to FIGS. 1 to 11, it can be seen that, when the content of the complex alkali activator included in the cement-free alkali-activated binder used in the cement-free mortar is 8˜10 wt %, the compressive strength of the cement-free mortar is 30 MPa or more.

Further, it can be seen that, in the cement-free alkali-activated binders (NaOH: 2 wt %) prepared in Examples 1 to 5 and the cement-free alkali-activated binders (NaOH: 3 wt %) prepared in Examples 6 to 10, the compressive strength of the cement-free mortar is linearly increased until the amount of added sodium carbonate (Na₂CO₃) becomes 5 wt %, and is decreased when the amount thereof becomes more than 5 wt %. However, it can be ascertained that, in the cement-free alkali-activated binders (NaOH: 4 wt % or more) prepared in Examples 11 to 25, the compressive strength of the cement-free mortar is continuously increased when the amount of added sodium carbonate (Na₂CO₃) is increased.

### Test Example 2

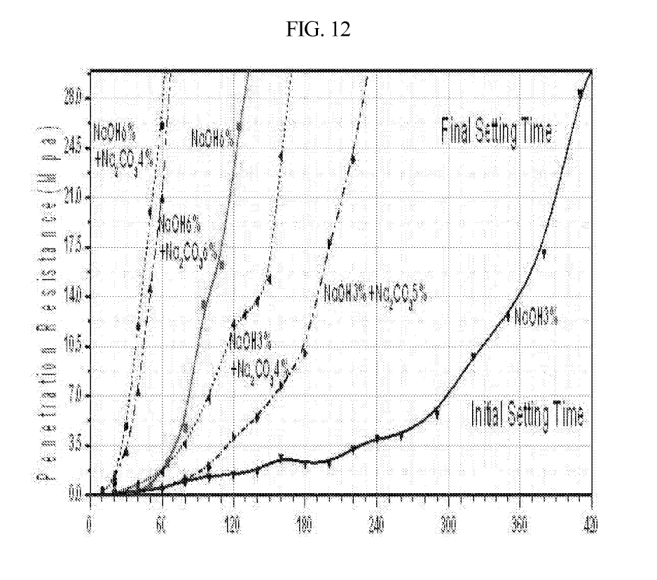

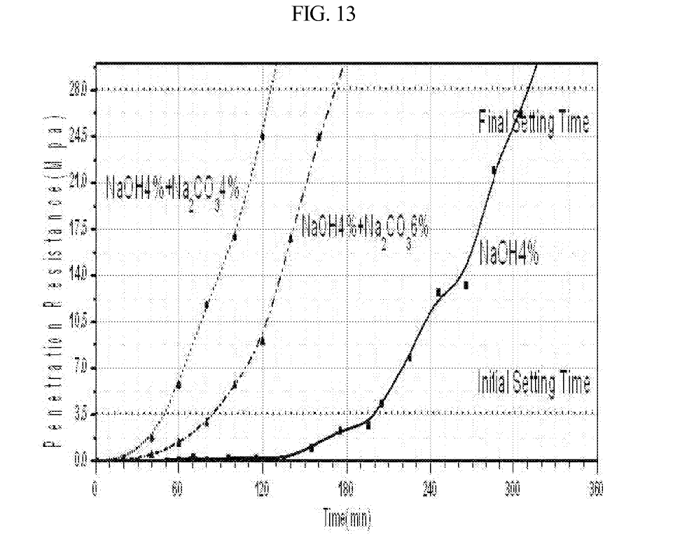

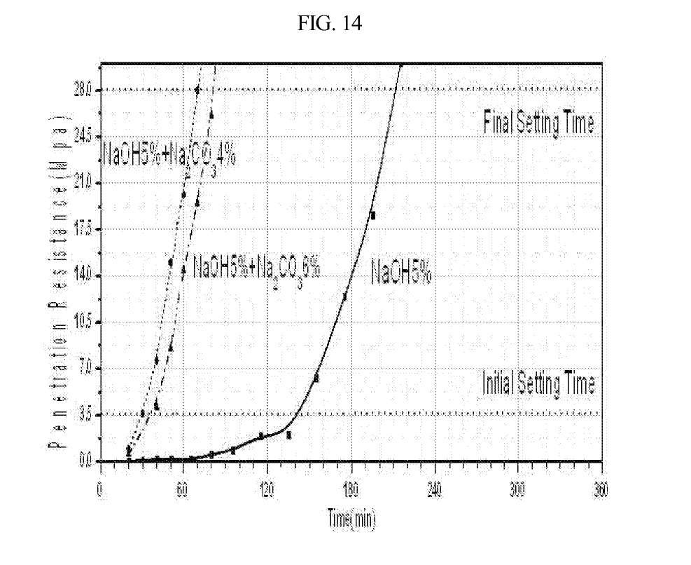

The setting characteristics of the cement-free mortars manufactured in Examples 26 to 50 depending on the content of a complex alkali activator were tested, and the results thereof are shown in FIGS. 12 to 14.

Referring to FIGS. 12 to 14, it can be seen that a complex alkali activator, that is, a combination of sodium hydroxide and sodium carbonate had a remarkable influence on the quick-setting characteristics of the cement-free mortars.

That is, it can be seen that, when only sodium hydroxide is added, the setting time of the cement-free mortar is increased as the amount of the added sodium hydroxide is increased, whereas, when a combination of sodium hydroxide and sodium carbonate is added, the setting time thereof is increased as the amount of the added sodium carbonate in the combination thereof (complex alkali activator) is increased.

The above results can be ascertained by the setting curve of sodium hydroxide 6 wt %, the setting curve of a combination of sodium hydroxide 3 wt % and sodium carbonate 4 wt % and the setting curve of a combination of sodium hydroxide 3 wt % and sodium carbonate 5 wt %.

Further, the increase in the amount of added sodium hydroxide predominantly influences the decrease in the setting time of the cement-free mortar. In this case, when sodium carbonate is added, the setting time thereof is controlled. That is, it can be seen that the setting of the cement-free mortar is effectively delayed as the amount of added sodium carbonate is increased.

The above test results were the same as those obtained when cement-free concretes were used, although not specifically described.

Therefore, from the above test results, it can be seen that when the cement-free alkali-activated binder of the present invention includes the complex alkali activator containing a hydroxide ion (OH⁻) and a carbonate ion (CO₃²⁻), that is, when anion groups of a hydroxide ion (OH⁻) and a carbonate ion (CO₃²⁻) are combined, the strength of the mortar and/or concrete including the cement-free alkali-activated binder becomes stable and uniform to improve the strength performance thereof, and the combination ratio of the anion groups of the complex alkali activator can be adjusted to control the setting time of the cement-free mortar and/or concrete.

Further, the concrete including cement-free alkali-activated binder can be used to manufacture secondary cement-free concrete products, such as light-weight bricks, bricks, pavement blocks, revetment blocks, fish-way blocks, sewage pipes, boundary stones, concrete pipes and the like, and can be used to manufacture cement-free concrete structures. As such, the secondary cement-free concrete products and cement-free concrete structures manufactured using the concrete including cement-free alkali-activated binder may include a nonsodium-based alkali-activated binder. In this case, the strength thereof become more stable and uniform, and the strength thereof can be maintained, thus improving the quality thereof.

Further, although not mentioned in Examples, the above test results are similar to those obtained when a combination of barium hydroxide and calcium carbonate was used as the complex alkali activator, that is, when the anion groups, that is, a hydroxide ion (OH⁻) and a carbonate ion (CO₃²⁻) included in the complex alkali activator of the cement-free alkali-activated binder are combined at a predetermined ratio without regard to the cation bonded with an anion. Further, the above test results are similar to those obtained even when fly ash was used instead of the blast furnace slag of the cement-free alkali-activated binder used in the above-mentioned Examples and Test Examples.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cement-free alkali-activated binder, comprising:
a source material selected from the group consisting of slag, fly ash, meta-kaolin, and a combination thereof; and
a complex alkali activator including an alkaline hydroxide and a carbonate.

2. The cement-free alkali-activated binder of claim 1, wherein the source material is included in an amount of 88 to 96 wt %, and the complex alkali activator is included in an amount of 4 to 12 wt %, based on the total amount of the cement-free alkali-activated binder.

3. The cement-free alkali-activated binder of claim 1, wherein a weight ratio of the alkaline hydroxide and the carbonate of the complex alkali activator is 2 to 4:4 to 6.

4. The cement-free alkali-activated binder of claim 1, wherein the alkaline hydroxide is selected from the group consisting of potassium hydroxide, sodium hydroxide, calcium hydroxide, magnesium hydroxide, and barium hydroxide, and a combination thereof.

5. The cement-free alkali-activated binder of claim 1, wherein the carbonate is selected from the group consisting of potassium carbonate, sodium carbonate, magnesium carbonate, barium carbonate, and a combination thereof.

6. A cement-free mortar, comprising the cement-free alkali-activated binder of claim 1.

7. The cement-free mortar of claim 6, further comprising sand, wherein the cement-free alkali-activated binder is mixed with the sand in a weight ratio of 1:2 to 3.

8. A cement-free concrete, comprising the cement-free alkali-activated binder of claim 1.

9. A cement-free concrete product, manufactured using the cement-free concrete of claim 8.

10. The cement-free concrete product of claim 9, wherein the cement-free concrete product is selected from the group consisting of a brick, a block, a tile, a sewage pipe, a boundary stone, a concrete pile, prestressed concrete, a concrete panel, a concrete pipe, a manhole, a foamed concrete, a concrete structure, and a combination thereof.

11. A cement-free mortar, comprising the cement-free alkali-activated binder of claim 2.

12. A cement-free mortar, comprising the cement-free alkali-activated binder of claim 3.

13. A cement-free mortar, comprising the cement-free alkali-activated binder of claim 4.

14. A cement-free mortar, comprising the cement-free alkali-activated binder of claim 5.

15. A cement-free concrete, comprising the cement-free alkali-activated binder of claim 2.

16. A cement-free concrete, comprising the cement-free alkali-activated binder of claim 3.

17. A cement-free concrete, comprising the cement-free alkali-activated binder of claim 4.

18. A cement-free concrete, comprising the cement-free alkali-activated binder of claim 5.

19. The cement-free alkali-activated binder of claim 1, wherein the source material includes slag, and the alkaline hydroxide includes sodium hydroxide, and the carbonate includes sodium carbonate.

20. The cement-free alkali-activated binder of claim 19, wherein the slag is included in an amount of 88 to 96 wt %, the complex alkali activator is included in an amount of 4 to 12 wt %, based on the total amount of the cement-free alkali-activated binder, and a weight ratio of the sodium hydroxide and the sodium carbonate is 2 to 4:4 to 6.
